(19) United States
(12) Patent Application Publication
(10) Pub. No.: US 2025/0038545 A1
(43) Pub. Date: Jan. 30, 2025

(54) BATTERY PACK, AND APPARATUS AND METHOD FOR MANAGING SAME

(71) Applicant: LG ENERGY SOLUTION, LTD., Seoul (KR)

(72) Inventor: Young Joong KIM, Daejeon (KR)

(73) Assignee: LG ENERGY SOLUTION, LTD., Seoul (KR)

(21) Appl. No.: 18/715,985

(22) PCT Filed: Mar. 6, 2023
(86) PCT No.: PCT/KR2023/003035

§ 371 Date: Jun. 3, 2024

(30) Foreign Application Priority Data
Mar. 14, 2022 (KR) 10-2022-0031618

(51) Int. Cl. H02J 7/00; H01M 10/42; H01M 10/44; H01M 10/46

(52) U.S. Cl. CPC H02J 7/00032; H01M 10/425; H01M 10/441; H01M 10/46; H02J 7/0013; H02J 7/0048; H02J 7/00714; H01M 2010/4271

(57) ABSTRACT

An aspect of the present disclosure includes a battery pack including a battery including a plurality of chargeable and dischargeable battery cells, a communication unit configured to transmit an initial state of charge (SOC) of the battery to an external device and receive a target SOC from the external device, an SOC estimation unit configured to estimate an SOC of the battery, a control unit configured to output an SOC adjustment signal for adjusting the SOC of the battery according to the target SOC, and an SOC adjustment unit configured to adjust the SOC of the battery according to the SOC adjustment signal.

### TECHNICAL FIELD

The inventive concept relates to a battery pack and a management apparatus thereof, and more particularly, to a battery pack capable of wireless communication and a battery pack management apparatus and method for remotely managing the battery pack using wireless communication.

### BACKGROUND ART

A rechargeable battery capable of charging and discharging, that is, a battery, is widely used as an energy source for mobile devices such as smartphones. In addition, batteries are also used as an energy source for eco-friendly vehicles such as electric vehicles and hybrid electric vehicles, which are proposed as a solution to air pollution caused by gasoline vehicles and diesel vehicles using fossil fuels. The types of applications using batteries are becoming very diverse, and it is expected that batteries will be applied to more fields and products than now.

Such a battery is generally used in the form of a battery pack rather than being used as a single battery cell. A battery pack includes at least one battery module, and the battery module may include a plurality of battery cells. In addition, the battery includes a Battery Management System (BMS) that manages overall states of battery cells, battery modules, or battery packs.

Meanwhile, when the battery pack is not used for a long period of time, it is necessary to manage the battery pack according to the situation in which the battery pack is placed. That is, when the battery pack is stored for a long period of time, transported, or disposed of, it is necessary to lower the state of charge (SOC) of the battery pack according to the situation. For example, when a battery pack is stored for a long time under a full charge condition after shipment, problems such as damage to the battery pack may occur, so it is desirable to manage the SOC at a low level. That is, if the battery pack is stored in a full charge state for a long period of time or stored at a high temperature, many problems such as leakage of electrolyte of the battery pack and possibility of explosion may occur. In addition, in the case of applications used in various external environments other than indoors, there is always a risk during long-term storage. Therefore, the lifespan of the battery is shortened, and the battery is replaced before such a problem occurs. As a result, the replacement cycle of the battery is shortened, resulting in a problem in that maintenance costs are high.

However, in order to manage SOC of existing battery packs, it is common for a user to individually connect a measuring device to each individual battery pack to measure a voltage and convert the voltage into an SOC suitable for the battery pack. However, this conventional method is very cumbersome to check the SOC of each battery pack, and even if the SOC is lowered according to the purpose, it takes a very long time to discharge each battery pack by connecting it to the system.

As the related art, there are the following documents.

Korean Patent Registration No. 10-1749730

### DISCLOSURE

### Technical Problem

The inventive concept provides a battery pack capable of wireless communication and controlled from the outside in a specific situation.

The inventive concept provides a battery pack management apparatus and method capable of wirelessly controlling a battery pack in a specific situation.

The inventive concept provides a battery pack management apparatus and method for automatically controlling the battery pack in a suitable state through a wireless control signal provided in the environment when the battery pack is located in the corresponding place during transportation, storage, or disposal of the battery pack.

### Technical Solution

A battery pack according to an aspect of the inventive concept includes a battery including a plurality of chargeable and dischargeable battery cells, a communication unit configured to transmit an initial state of charge (SOC) of the battery to an external device and receive a target SOC from the external device, an SOC estimation unit configured to estimate an SOC of the battery, a control unit configured to output an SOC adjustment signal for adjusting the SOC of the battery according to the target SOC, and an SOC adjustment unit configured to adjust the SOC of the battery according to the SOC adjustment signal.

The battery pack is introduced into a specific place according to a specific situation and is configured to wake up according to a wake-up signal from the external device.

The wake-up signal is input at a predetermined cycle.

The target SOC is input differently according to a battery pack operation status such as a long-term storage, transportation or disposal of the battery pack.

The control unit compares the SOC and the target SOC of the battery estimated by the SOC estimation unit and the target SOC of the battery to output the SOC adjustment signal.

The SOC adjustment unit includes a switch connected to the battery and a discharge resistor connected to the switch, and the switch is driven according to the SOC adjustment signal to allow the battery to be discharged through the discharge resistor so that the SOC of the battery is lower than the target SOC.

The discharge resistor includes a variable resistance, and the control unit varies the variable resistance of the discharge resistor to control a temperature of the battery pack.

A battery pack management apparatus according to another aspect of the inventive concept includes at least one battery pack configured to communicate with an outside of the at least one battery pack, and a remote managing device spaced apart from the at least one battery pack and configured to communicate with the at least one battery pack, wherein the remote managing device sets a first target SOC and transmits the first target SOC to the at least one battery pack, and the at least one battery pack adjusts a pack SOC according to the first target SOC.

The at least one battery pack is introduced into a specific place according to a specific situation and is configured to wake up according to a first wake-up signal from the remote managing device.

The first target SOC is different depending on a battery pack operation status, such as long-term storage, transportation or disposal of the at least one battery pack.

The at least one battery pack includes a battery including a plurality of chargeable and dischargeable battery cells, a first communication unit configured to transmit an initial SOC of the battery to the remote managing device and receive the first target SOC from the remote managing device, an SOC estimation unit configured to estimate the SOC of the at least one battery pack, a control unit configured to adjust the SOC of the battery according to a comparison result of the first target SOC and the pack SOC, and an SOC adjustment unit configured to adjust the SOC of the battery according to a control of the control unit.

The control unit outputs a control signal for adjusting the pack SOC when the pack SOC is larger than the first target SOC.

The SOC adjustment unit includes a switch connected to the battery and a discharge resistor connected to the switch, wherein the switch is driven based on a control signal of the control unit to allow the battery to be discharged through the discharge resistor.

The discharge resistor includes a variable resistance, and the battery is discharged by adjusting the variable resistance of the discharge resistor so that a discharge current flowing through the discharge resistor is lower than a predetermined reference current.

The remote managing device includes a second communication unit configured to transmit a second wake-up signal and a second target SOC to the at least one battery pack and receive the initial SOC from the at least one battery pack, and a management unit configured to generate the second wake-up signal and the second target SOC and manage the at least one battery pack through the second communication unit.

The battery pack management apparatus further includes a battery rack configured to accommodate the at least one battery pack and communicate with the at least one battery pack through wireless communication or wired communication.

The remote managing device manages the at least one battery pack accommodated in the battery rack through the battery rack.

A battery pack management method according to another aspect of the inventive concept includes introducing at least one battery pack to a specific place depending on a specific situation, waking up the at least one battery pack by a wake-up signal, estimating a pack SOC of the at least one battery pack, receiving a target SOC from a remote managing device, comparing the pack SOC and the target SOC, transmitting to the remote managing device that the at least one battery pack is configured for the specific situation if the pack SOC is lower than the target SOC based on a comparison result, and adjusting the pack SOC if the pack SOC is higher than the target SOC based on the comparison result.

The battery pack management method further includes measuring a discharge current while adjusting the pack SOC and comparing the measured discharge current with a reference current, and adjusting an SOC by increasing a resistance value of a discharge resistor if the discharge current is higher than the reference current.

### Advantageous Effects

The battery pack according to the inventive concept includes a communication unit to adjust the SOC of the battery pack according to a control signal from an external remote managing device. That is, at least one battery pack of the inventive concept is capable of communication and is located in a specific place according to specific circumstances such as transportation, storage, or disposal, and adjusts the SOC of the battery pack according to the specific situation according to the control signal from the remote managing device. Therefore, according to the inventive concept, when transporting, storing, or disposing of a battery pack, the battery pack may be automatically controlled in a suitable state through a wireless control signal provided in the environment just by placing the battery pack in a corresponding place. That is, since the plurality of battery packs may be discharged at once without discharging by connecting each battery pack to the system in order to check the SOC of each of the plurality of battery packs, the time for controlling the SOC of the battery packs may be reduced.

### DESCRIPTION OF DRAWINGS

FIG. 1 is a block diagram illustrating a battery pack management apparatus according to an embodiment of the inventive concept.

FIG. 2 is a block diagram illustrating a battery pack and a remote managing device constituting a battery pack management apparatus according to an embodiment of the inventive concept.

FIG. 3 is a block diagram for explaining a battery pack management apparatus according to another embodiment of the inventive concept.

FIG. 4 is a flowchart illustrating a battery pack management method using a battery pack management apparatus according to an embodiment of the inventive concept.

### MODE FOR INVENTION

Hereinafter, exemplary embodiments of the inventive concept will be described in detail with reference to the accompanying drawings. However, the inventive concept is not limited to the embodiments disclosed below, but will be implemented in various different forms, and these embodiments are provided to complete the disclosure of the inventive concept, and to fully inform a person of ordinary skill in the scope of the invention. In the drawing, the thickness is enlarged and expressed in order to clearly express the various layers and each region, and the same symbols refer to the same elements in the drawings.

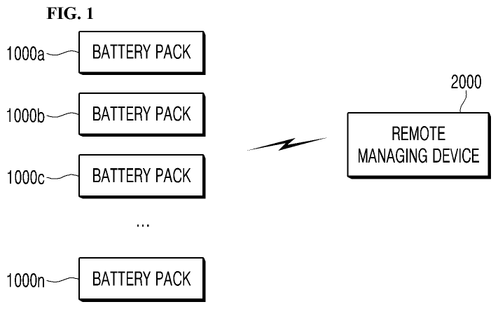

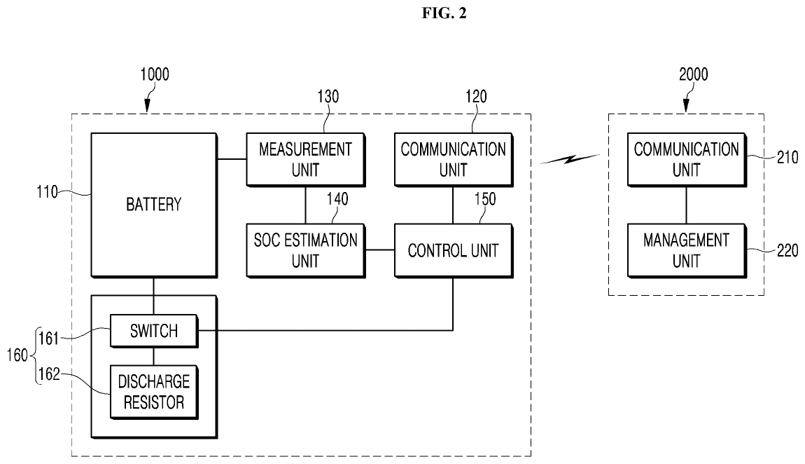

FIG. 1 is a block diagram for explaining a battery pack management apparatus according to an embodiment of the inventive concept, and FIG. 2 is a block diagram illustrating a battery pack and a remote managing device constituting a battery pack management apparatus according to an embodiment of the inventive concept.

Referring to FIGS. 1 and 2, the battery pack management apparatus according to an embodiment of the inventive concept may include at least one battery pack 1000a to 1000n; 1000, and a remote managing device 2000 that is spaced apart from the at least one battery pack 1000 and manages the at least one battery pack 1000 using wireless communication. Here, at least one battery pack 1000 may be formed in plurality, preferably two or more, and at least one remote managing device 2000 may be provided, for example, one each in a predetermined range of a specific place. Hereinafter, a plurality of battery packs 1000 and one remote managing device 2000 will be described. That is, the plurality of battery packs 1000 are introduced and located in a specific place according to specific circumstances such as long-term storage, transportation, and disposal. For example, a plurality of battery packs 1000 may be located in a predetermined place (for example, a storage warehouse) for long-term storage, may be located in a predetermined space (for example, a container) for transportation, and may be located in a predetermined space (for example, a storage yard or warehouse) for disposal. In this case, each of the plurality of battery packs 1000 may be capable of wireless communication. In addition, the remote managing device 2000 may be provided in a specific place according to a specific situation and control a plurality of battery packs 1000 located in the corresponding situation or place. At this time, the remote managing device 2000 may remotely control the plurality of battery packs 1000 through wireless communication. That is, the remote managing device 2000 may wirelessly control the plurality of battery packs 1000 located in a storage warehouse for long-term storage, accommodated in a container for transportation, or stored in an open yard for disposal. At this time, the remote managing device 2000 may control the SOC of the battery pack 1000 to be adjusted to a specific situation, etc., remotely, that is, separated from the plurality of battery packs 1000 by a predetermined distance and using wireless communication. That is, the battery pack 1000 must have a charge amount below a predetermined level, that is, SOC, in specific situations such as long-term storage, transportation, and disposal, and to this end, the inventive concept remotely controls the battery pack 1000 so that the remote managing device 2000 has an SOC suitable for a corresponding situation. A battery pack management apparatus according to an embodiment of the inventive concept including at least one battery pack 1000 and at least one remote managing device 2000 will be described in detail for each component as follows.

### 1. Battery Pack

The battery pack 1000 may include a battery 110 including a plurality of chargeable and dischargeable battery cells, a communication unit 120 for communication with a remote managing device 2000, a measurement unit 130 for measuring the state of the battery 110, an SOC estimation unit 140 for estimating the SOC of the battery 110 using measurement data through the measurement unit 130, a control unit 150 for controlling the SOC of the battery 110 according to the estimation result of the SOC estimation unit 140 and the control signal according to the environment setting value of the external remote managing device 2000, and an SOC adjustment unit 160 for adjusting the SOC of the battery 110 according to the control signal of the control unit 150. Meanwhile, the battery pack 1000 is mounted on a predetermined electric/electronic device during normal operation and provides electric energy required for driving the electric/electronic device. That is, the battery pack 1000 may be charged and discharged to provide electrical energy to electrical and electronic devices during normal operation, and discharged to adjust the SOC under the control of the remote managing device 2000 in a specific situation during long-term storage, transportation or disposal. For general operation of the battery pack 1000, a charge/discharge switch (not shown) controlled by the control unit 150 may be provided. However, since the inventive concept describes the battery pack 1000 during long-term storage, transportation, or disposal, configuration during general operation is not mentioned.

The communication unit 120, the measurement unit 130, the SOC estimation unit 140, and the control unit 150 may be integrated as components constituting a battery pack management device (Pack BMS).

### 1.1. Battery

The battery 110 may be charged and discharged to provide energy necessary for driving electric and electronic devices. That is, the battery 110 may be charged and store electrical energy of a predetermined capacity and discharged to provide electrical energy for operation of the electric/electronic device. The battery 110 may include at least one battery pack, and the battery pack may include a plurality of battery modules. In addition, the battery module may include a plurality of battery cells capable of charging and discharging. That is, the battery 110 includes a plurality of battery cells, a plurality of battery cells may be bundled into a predetermined unit to form a battery module, and a plurality of battery modules may form one battery pack. Meanwhile, a plurality of battery cells may be connected in series and/or in parallel in various ways to meet the specifications of an electric/electronic device. Of course, a plurality of battery modules or battery packs each including a plurality of battery cells may also be connected in series and/or parallel. Here, the type of battery cell is not particularly limited, and may include, for example, a lithium ion battery, a lithium polymer battery, a nickel cadmium battery, a nickel hydride battery, a nickel zinc battery, and the like.

### 1.2. Communication Unit

The communication unit 120 may be provided for communication between the battery pack 1000 and the remote managing device 2000. The communication unit 120 receives a predetermined signal from the remote managing device 2000 and transmits the received predetermined signal to the control unit 150. At this time, the signal supplied from the remote managing device 2000 through the communication unit 120 may include environment setting values, and the environment setting value may include a target SOC for managing the SOC of a battery pack according to a specific situation and a specific place. That is, the target SOC may be different according to long-term storage, transportation, or disposal of the battery pack 1000, and the communication unit 120 may receive a target SOC signal according to the situation from the remote managing device 2000. The environment setting value including the target SOC according to the specific situation and place may be supplied to the control unit 150 through the communication unit 120 as a predetermined signal. Also, a wakeup signal may be input from the remote managing device 2000 through the communication unit 120. According to the wake-up signal input through the communication unit 120, the control unit 150 in the IDLE state wakes up and then receives the SOC setting signal through the communication unit 120, so that the control unit 150 may adjust the SOC of the battery pack 1000 to suit a specific situation and a specific location. In this case, the wake-up signal may be received through the communication unit 120 from the remote management unit 2000 at predetermined intervals. Accordingly, the battery pack 1000 may be woken up at predetermined cycles. Also, the communication unit 120 may transmit the SOC estimation value of the battery pack 1000 to the remote managing device 2000. That is, the communication unit 120 may transmit the estimated initial SOC to the remote managing device 2000 after the battery pack 1000 wakes up. The communication unit 120 may be a communication module of various types, and for example, a wireless communication module such as Bluetooth or Zigbee may be used.

### 1.3. Measurement Unit

The measurement unit 130 may be provided to measure the state of the battery 110. The measurement unit 130 measures states such as voltage, current, and temperature of the battery 110. To this end, the measurement unit 130 may include a voltage sensor for measuring voltage, a current sensor for measuring current, and a temperature sensor for measuring temperature. At this time, the measurement unit 130 may measure states such as current and voltage of the battery module and battery cell. That is, the state of each of a plurality of battery cells may be measured, or the state of a battery module in which a plurality of battery cells are bundled may be measured. To this end, the measurement unit 130 may include a plurality of sensors. That is, at least one voltage sensor, at least one current sensor, and at least one temperature sensor may be included. The voltage sensor, current sensor, and temperature sensor periodically measure voltage, current, and temperature of the battery 110 and provide measurement results to the SOC estimation unit 140. The measurement result may be provided to the SOC estimation unit 140 as an analog signal or a digital signal. The voltage sensor measures the voltage applied between the positive and negative electrodes of the battery 110 and provides the measured voltage to the SOC estimation unit 140. As an example, the voltage sensor may include a differential amplifier circuit outputting a voltage signal corresponding to a voltage difference between the positive and negative terminals of the battery 110. Here, the voltage sensor may measure the AC voltage. In addition, the current sensor is a sense resistor or a Hall sensor, and generates a signal corresponding to the magnitude of the charging current and provides the generated signal to the SOC estimation unit 140. The current sensor may measure not only the charging current but also the magnitude of the discharging current. Here, the current sensor may measure an alternating current. Also, the temperature sensor may be, for example, a thermal coupler used for temperature measurement. The temperature sensor generates a signal corresponding to the temperature of the battery 110 and provides the generated signal to the SOC estimation unit 140.

### 1.4. SOC Estimation Unit

The SOC estimation unit 140 estimates the SOC of the battery 110. There may be various methods for estimating SOC. As a first method, the SOC of the battery 110 may be estimated using the capacity of the battery 110 estimated from the SOH estimation unit (not shown) and the current of the battery 110 measured and averaged from the measurement unit 130. That is, the SOC estimation unit 140 may estimate the SOC of the battery 110 by integrating the calculated average current value for a predetermined time and dividing it by the battery capacity estimated from the SOH estimation unit. As a second method, the SOC estimation unit 140 may estimate the SOC using the open circuit voltage (OCV) of the battery 110. That is, the SOC may be estimated by extracting the SOC matched with the OCV measured by the measurement unit 130 by referring to the initial OCV table. For example, if the OCV measured from the measurement unit 130 is 3560 mV, it may be estimated that the SOC is 40% by referring to the OCV table. In this case, the SOC may be estimated by estimating the initial SOC estimated by OCV and measuring the discharge current. As a third method, the SOC estimation unit 140 may estimate the SOC by measuring the impedance of the battery 110. As a fourth method, the SOC estimation unit 140 estimates the SOC of each battery 110 using measurement data after charging and discharging the battery 110. For example, the SOC estimation unit 140 calculates a first SOC after discharging when battery discharge occurs, and calculates a second SOC after charging when charging continues after discharging. Also, when re-discharging continues after charging, the third SOC is calculated after re-discharging. Then, these operations are repeatedly performed. In this case, the SOC estimation unit 140 may estimate the SOC of the battery using voltage, current, and temperature measurement value information based on a Kalman filter or an extended Kalman filter. That is, the SOC estimation unit 140 models the battery's OCV, internal resistance, and resistance-capacitor parallel circuit as an equivalent circuit connected in series, estimates the SOC using a linear or non-linear function and a current integration method using the factors of the equivalent circuit model as variables, and corrects the estimated SOC using the sensing data generated in real time by the measurement unit 130 and the calculated average voltage and current, so that the SOC for the battery may be estimated.

### 1.5. Control Unit

The control unit 150 may generate a control signal for managing and controlling the battery 110 according to a result of estimating the state of the battery 110 according to the SOC estimation unit 140. At this time, the control unit 150 manages the battery 110 according to the target SOC supplied from the external remote managing device 2000 through the communication unit 120. That is, the control unit 150 receives the SOC estimation value of the battery 110, that is, the pack SOC, from the SOC estimation unit 140, receives the target SOC from the remote managing device 2000 through the communication unit 120, and compares the pack SOC with the target SOC. As a result of the comparison, if the target SOC is higher than the pack SOC (i.e., the pack SOC is lower than the target SOC), it is determined that the SOC of the battery pack in a specific situation, that is, the SOC is low. Conversely, if the target SOC is lower than the pack SOC as a result of the comparison (i.e., the pack SOC is higher than the target SOC), it is determined that the SOC of the battery pack in a specific situation, that is, the SOC is high. If the target SOC is lower than the pack SOC, the pack SOC must be reduced below the target SOC. To this end, the control unit 150 generates a predetermined control signal (i.e., the SOC control signal), supplies the generated predetermined control signal to the SOC adjustment unit 160, and allows the battery 110 to be discharged through the SOC adjustment unit 160 to reduce the pack SOC. In addition, the control unit 150 continues discharging the battery 110 until the pack SOC becomes lower than the target SOC. Meanwhile, the control unit 150 measures the current flowing through the discharge resistor 162 of the SOC adjustment unit 160 by applying the SOC control signal while adjusting the pack SOC by discharging the battery 110 through the SOC adjustment unit 160. The discharge resistor 162 may be made of a variable resistor, and the control unit 150 may compare the current flowing through the discharge resistor 162, that is, the discharge current Ivar and the reference current Ith, and adjust the resistance value of the discharge resistor 162 until the discharge current Ivar is equal to or less than the reference current Ith. Here, the reference current Ith may be set to a value specified by the battery pack manufacturer so that the battery pack temperature does not become too high during discharging. In addition, the resistance value of the discharge resistor may be adjusted in stages based on the difference between the pack SOC and the target SOC. That is, the discharge resistor may be set low in order to adjust the SOC at a faster time.

### 1.6. SOC Adjustment Unit

The SOC adjustment unit 160 may be provided to reduce the SOC of the battery 110 by discharging charged charges of the battery 110. To this end, the SOC adjustment unit 160 is connected to the battery 110 and the control unit 150 to discharge the charge of the battery 110 according to the control signal of the control unit 150, and accordingly, may lower the SOC of the battery 110. The SOC adjustment unit 160 may include a switch 161 connected to the battery 110 and a discharge resistor 162 connected to the switch 161. At this time, the switch 161 and the discharge resistor 162 may be connected in series. The switch 161 may be controlled on/off according to a control signal from the control unit 150. For example, the switch 161 may be turned on in response to a predetermined high level control signal. On the other hand, the switch 161 may be turned off in response to a low level control signal. While the switch 161 is turned on, electrical energy of the battery 110 is consumed by the discharge resistor 162, so that the SOC of the battery pack may gradually decrease. Meanwhile, the discharge resistor 162 may be a variable resistor. Here, the resistance of the discharge resistor 162 may be varied while adjusting the SOC. That is, as measuring the current flowing through the discharge resistor 162, that is, the discharge current Ivar, if the discharge current Ivar is higher than the predetermined reference current Ith, the battery 110 may be discharged by increasing the resistance value of the discharge resistor 162. At this time, the battery 110 is discharged while increasing the resistance value of the discharge resistor 162 until the discharge current Ivar becomes lower than the reference current Ith.

In addition, in order to increase the speed of SOC regulation, the discharge resistor value must be adjusted low in order to set the discharge current Ivar value high, as described above, for the safety of the battery, the discharge current Ivar is adjusted within a range lower than the reference current Ith.

### 2. Remote Managing Device

At least one remote managing device 2000 may be provided, for example, one each in a predetermined range of a specific place. That is, the remote managing device 2000 may be provided in a communication range, at least one may be provided according to the communication sensitivity between the remote managing device 2000 and the battery pack 1000 and the width of a place where the plurality of battery packs 1000 are located. For example, one remote managing device 2000 may be provided at a predetermined location, or a plurality of remote managing devices 2000 may be provided at predetermined intervals at a predetermined location. The remote managing device 2000 may include a communication unit 210 for communication with the plurality of battery packs 1000 and a management unit 220 for remotely managing the SOC of the battery packs 1000.

### 2.1. Communication Unit

The communication unit 210 may be provided for communication between the battery pack 1000 and the remote managing device 2000. That is, the communication unit 210 of the remote managing device 2000 wirelessly communicates with the communication unit 120 of the battery pack 1000. The communication unit 210 may transmit a control signal, that is, a target SOC signal according to an environment setting value from the management unit 220 to the plurality of battery packs 1000. The communication unit 210 may be a communication module of various types, and for example, a wireless communication module such as Bluetooth or Zigbee may be used.

### 2.2. Management Unit

The management unit 220 may be provided to manage the plurality of battery packs 1000 located in a specific location according to specific circumstances. That is, the management unit 220 may control a plurality of battery packs 1000 located in a specific place to have SOCs suitable for specific situations for long-term storage, transportation, or disposal of the battery packs 1000. At this time, the management unit 220 may generate a control signal of an environment setting value according to a specific situation. The environment setting value may include a target SOC signal for managing the SOC of the battery pack 1000 according to a specific situation or a specific region. That is, the target SOC may be different according to long-term storage, transportation, or disposal of the battery pack 1000, and the management unit 220 may generate a target SOC signal according to a corresponding situation. For example, in the case of long-term storage and transportation, the target SOC may be set to 20% to 30%, and in the case of disposal, the target SOC may be set to 0%. The target SOC according to this specific situation may be stored in a predetermined memory unit (not shown), and the management unit 220 may read information data stored in the memory unit and transmits the read information data to the battery pack 1000 through the communication unit 210. In addition, the target SOC may be stored in the memory unit after being adjusted by a managing device according to a specific situation. Meanwhile, the management unit 220 may generate a wake-up signal for waking up the plurality of battery packs 1000 located in a specific place and transmit the wake-up signal to the plurality of battery packs 1000 through the communication unit 210.

The battery pack 1000 according to an embodiment of the inventive concept configured as described above includes a communication unit 120 to adjust the SOC of the battery pack 1000 according to a control signal from an external device, that is, the remote managing device 2000. That is, in the battery pack management apparatus of the inventive concept, at least one battery pack 1000 is located in a specific place according to a specific situation, and according to a control signal from the remote managing device 2000, the SOC of the battery pack 1000 is adjusted according to a specific situation. To this end, in the battery pack 1000, the communication unit 120 receives a control signal from the remote managing device 2000 and transmits it to the control unit 150, and the control unit 150 compares the SOC of the battery pack estimated by the SOC estimation unit 140 with the target SOC input from the remote managing device 2000 according to the state of the battery 110 measured through the measurement unit 130 to adjust the SOC of the battery pack using the SOC adjustment unit 160. At this time, the control unit 150 compares the target SOC from the remote managing device 2000 with the pack SOC through the SOC estimation unit 140 and when the pack SOC is higher than the target SOC, lowers the pack SOC by discharging the battery 110 using the SOC adjustment unit 160. As a result, when the plurality of battery packs 1000 are located in a specific place according to a specific situation, the inventive concept wirelessly controls the battery pack 1000 so that the battery pack has an SOC suitable for the specific situation under the control of the remote managing device 2000. Therefore, according to the inventive concept, when transporting, storing, or disposing of a battery pack, the battery pack may be automatically controlled in a suitable state through a wireless control signal provided in the environment just by placing the battery pack in a corresponding place. That is, since the plurality of battery packs may be discharged at once without discharging by connecting each battery pack to the system in order to check the SOC of each of the plurality of battery packs, the time for controlling the SOC of the battery packs may be reduced.

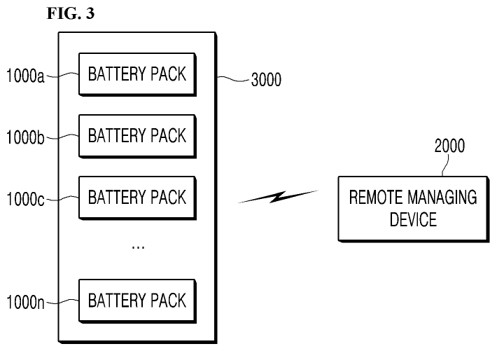

Meanwhile, in the inventive concept, a plurality of battery packs 1000 may be accommodated in a predetermined container and positioned at a specific location. That is, as shown in FIG. 3, a plurality of battery packs 1000 may be accommodated in a battery rack 3000 and accommodated in a specific place. Of course, the plurality of battery packs 1000 may be located at a specific location by providing the battery rack 3000 at a specific location and accommodating the plurality of battery packs 1000 in the battery rack 3000. At this time, the battery rack 3000 may communicate with the plurality of battery packs 1000. That is, the battery rack 3000 may be wired or wirelessly connected to each of the plurality of battery packs 1000. To this end, a wired communication terminal or a wireless communication terminal may be provided in the battery rack 3000. In addition, the battery rack 3000 communicatively connected to the plurality of battery packs 1000 may be wirelessly connected to the remote managing device 2000. Accordingly, the target SOC signal according to the environment setting value of the remote managing device 2000 may be supplied to each of the plurality of battery packs 1000 through the battery rack 3000.

Meanwhile, the remote managing device of the inventive concept may include a battery rack (not shown) in which battery packs are mounted, and a battery pack communication connector may be provided in the battery rack so that the battery packs mounted on the battery rack may be connected to the remote managing device through wired communication. In this case, the battery pack described above may be configured to include a wired communication connection unit.

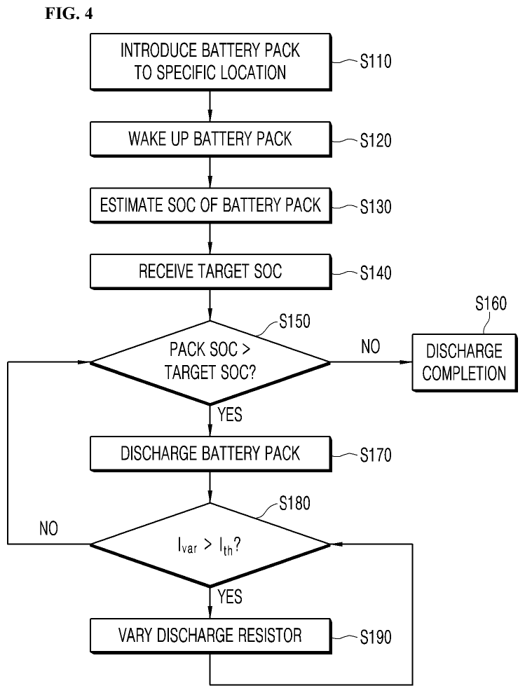

FIG. 4 is a flowchart illustrating a battery pack management method using a battery pack management apparatus according to an embodiment of the inventive concept.

Referring to FIG. 4, a battery pack management method according to an embodiment of the inventive concept may include a process S110 in which a plurality of battery packs 1000 are introduced to a specific place according to a specific situation, a process S120 in which the plurality of battery packs 1000 wake up by inputting a wake-up signal, a process S130 of estimating the SOC of each of the plurality of battery packs 1000, a process S140 of receiving a target SOC signal from a remote managing device 2000 located in a specific place, a process S150 in which each of the plurality of battery packs 1000 compares each pack SOC with a target SOC, a process S160 of notifying the remote managing device 2000 that the battery pack 1000 has been discharged when the pack SOC is lower than the target SOC as a result of the comparison, a process S170 of adjusting the SOC by discharging the battery 110 of the battery pack 1000 when the pack SOC is higher than the target SOC as a result of the comparison, a process S180 of measuring the discharge current Ivar and comparing the measured discharge current Ivar with the reference current Ith while adjusting the SOC of the battery, and a variable resistance adjusting process S190 of lowering the value of the discharge current Ivar by increasing the resistance value of the discharge resistor when the discharge current Ivar is higher than the reference current Ith. The battery pack management method according to an embodiment of the inventive concept will be described in detail for each process as follows.

S110: The plurality of battery packs 1000 are introduced and located in a specific place according to specific circumstances such as long-term storage, transportation, and disposal. For example, a plurality of battery packs 1000 may be located in a predetermined place (for example, a storage warehouse) for long-term storage, may be located in a predetermined space (for example, a container) for transportation, and may be located in a predetermined space (for example, a storage yard or warehouse) for disposal. In this case, each of the plurality of battery packs 1000 may be capable of wireless communication. In addition, the remote managing device 2000 may be provided in a specific place according to a specific situation and control a plurality of battery packs 1000 located in the corresponding situation or place. At this time, the remote managing device 2000 may remotely control the plurality of battery packs 1000 through wireless communication. That is, the remote managing device 2000 may wirelessly control the plurality of battery packs 1000 located in a storage warehouse for long-term storage, accommodated in a container for transportation, or stored in an open yard for disposal. Meanwhile, the battery pack 1000 is mounted on an electric/electronic device during normal operation to provide electrical energy to the electric/electronic device. Therefore, in the inventive concept, even before or after the battery pack 1000 is mounted on the electric/electronic device, it is separated from the electric/electronic device and introduced into a specific place under a specific situation.

S120: When a plurality of battery packs 1000 flow into a specific place where the remote managing device 2000 is installed, the management unit 220 of the emote managing device 2000 generates a wake-up signal and transmits the generated wake-up signal to the plurality of battery packs 1000 through the communication unit 210. The plurality of battery packs 1000 are woken up by inputting a wake-up signal from the remote managing device 2000. That is, each communication unit 120 of the plurality of battery packs 1000 receives a wake-up signal from the communication unit 210 of the remote managing device 2000 and transmits the received wake-up signal to the control unit 150, and the control unit 150 wakes up the battery pack 1000 by inputting a wakeup signal. According to the wake-up signal, the control unit 150 wakes up the battery pack 1000 by driving the battery 110 or driving a predetermined power supply unit (not shown) provided inside the battery pack 1000, and the battery pack 1000 is woken up by supplying power to components that is, the measurement unit 130, the SOC estimation unit 140, the control unit 150, constituting the battery pack 1000 from the battery 110 or a predetermined power supply unit. Of course, the wake-up signal may be applied to the battery 110 or a predetermined power supply without passing through the control unit 150, and accordingly, the battery pack 1000 may be woken up by supplying power to components of the battery pack 1000 from the battery 110 or a predetermined power supply unit. Meanwhile, the wake-up signal may be input at predetermined cycles. That is, a wake-up signal may be input from the remote managing device 2000 at a predetermined period to wake up the battery pack 1000 at a predetermined period.

S130: After the battery pack 1000 wakes up, the SOC of the battery pack 1000, that is, the pack SOC is estimated, and the estimated initial SOC is transmitted to the remote managing device 2000 through the communication unit 120. There may be various methods for estimating SOC. As a first method, the SOC of the battery 110 may be estimated using the capacity of the battery 110 estimated from the SOH estimation unit (not shown) and the current of the battery 110 measured and averaged from the measurement unit 130. That is, the SOC estimation unit 140 may estimate the SOC of the battery 110 by integrating the calculated average current value for a predetermined time and dividing it by the battery capacity estimated from the SOH estimation unit. As a second method, the SOC estimation unit 140 may estimate the SOC using the open circuit voltage (OCV) of the battery 110. That is, the SOC may be estimated by extracting the SOC matched with the OCV measured by the measurement unit 130 by referring to the initial OCV table. In this case, the SOC may be estimated by estimating the initial SOC estimated by OCV and measuring the discharge current. The pack SOC may be estimated using various other methods.

S140: After transmitting the initial SOC of the battery pack 1000, the battery pack 1000 may receive a target SOC signal from the remote management unit 2000. That is, the target SOC signal generated from the management unit 220 of the remote management unit 2000 is transmitted to the communication unit 120 of the battery pack 1000 through the communication unit 210, and the communication unit 120 may receive and transmit the target SOC signal to the control unit 150. Here, the management unit 220 of the remote management unit 2000 may generate a target SOC signal for managing the SOC of a plurality of battery packs 1000 located in a specific place for long-term storage, transportation, or disposal of the battery pack 1000. That is, the target SOC may be different according to long-term storage, transportation, or disposal of the battery pack 1000, and the management unit 220 may generate a target SOC signal according to a corresponding situation. For example, in the case of long-term storage and transportation, the target SOC may be set to 20% to 30%, and in the case of disposal, the target SOC may be set to 0%.

The management unit 220 of the remote management unit 2000 may transmit an external discharge signal to the battery by comparing the difference between the received initial SOC of the battery pack 1000 and the target SOC. At this time, a first discharge rate designation signal for designating a discharge rate according to a difference between the initial SOC and the target SOC may be transmitted to the battery together with an external discharge signal or alone.

S150: The plurality of battery packs 1000 compare the pack SOC and the target SOC. That is, the control unit 150 receives the pack SOC estimated from the SOC estimation unit 140 and the target SOC from the remote management unit 2000 through the communication unit 120 and compares them. For example, the control unit 150 compares and determines whether the pack SOC is greater than the target SOC.

S160: The pack SOC is compared with the target SOC, and if the pack SOC is smaller than the target SOC, it transmits to the remote managing device 2000 that the battery pack 1000 has an SOC suitable for a specific situation. That is, when the pack SOC is smaller than the target SOC, a predetermined signal is transmitted to the remote managing device 2000 indicating that the battery 110 is discharged below a predetermined level.

S170: However, if the pack SOC is greater than the target SOC, the control unit 150 generates an SOC control signal and applies the generated SOC control signal to the SOC adjustment unit 160. The SOC adjustment unit 160 discharges the battery 110 by inputting the SOC control signal. That is, in the SOC adjustment unit 160 including the switch 161 and the discharge resistor 162, the switch 161 is turned on according to the SOC control signal from the control unit 150, so that charges charged in the battery 110 are discharged through the discharge resistor 162. By discharging the battery 110 using the SOC adjustment unit 160, the pack SOC is adjusted. Adjustment of the pack SOC is performed until the pack SOC becomes lower than the target SOC.

At this time, the control unit 150 receives a first discharge rate designation signal and transmits the received first discharge rate designation signal to the SOC adjustment unit 160, or compares the pack SOC and the target SOC to generate a second discharge rate designation signal based on the difference and transmit the generated second discharge rate designation signal to the SOC adjustment unit 160.

When there is a first or second discharge rate designation signal, the value of the discharge resistor 162 described later may be adjusted according to a designated discharge rate. If wanting to increase the discharge rate, it is possible to increase the discharge current by lowering the resistance value of the discharge resistor. However, even when the resistance value of the discharge resistor 162 is lowered to increase the discharge rate, as described in step S190 below, when the discharge current Ivar is higher than the reference current Ith, the resistance value of the discharge resistor is increased.

S180: The control unit 150 measures the current flowing through the discharge resistor 162 of the SOC adjustment unit 160 by applying the SOC control signal while adjusting the pack SOC by discharging the battery 110 through the SOC adjustment unit 160. The discharge resistor 162 may be formed of a variable resistor, and the control unit 150 compares the current flowing through the discharge resistor 162, that is, the discharge current Ivar and the reference current Ith.

S190: When the discharge current Ivar flowing through the discharge resistor is compared with a predetermined reference current Ith and the discharge current Ivar is higher than the reference current Ith, the resistance value of the discharge resistor 162 may be increased. Here, the reference current Ith may be a safe current value set so that the temperature of the battery pack does not become too high during discharging with a value specified by the battery pack manufacturer, and is a safe current value for battery discharge.

As described above, although the technical idea of the inventive concept has been specifically described according to the above embodiment, it should be noted that the above embodiments are for the purpose of explanation and not limitation. In addition, those skilled in the art in the technical field of the inventive concept will be able to understand that various embodiments are possible within the scope of the spirit of the inventive concept.

The symbols and their names used in the drawings of the present invention are as follows.

| | |
|---|---|
| 1000: battery pack | 2000: remote managing device |
| 3000: battery rack | 110: battery |
| 120: communication unit | 130: measurement unit |
| 140; SOC estimation unit | 150: control unit |
| 160: SOC adjustment unit | 210: communication unit |
| 220: management unit | |

1. A battery pack comprising:
a battery including a plurality of chargeable and dischargeable battery cells;
a communication unit configured to transmit an initial state of charge (SOC) of the battery to an external device and receive a target SOC from the external device;
an SOC estimation unit configured to estimate an SOC of the battery;
a control unit configured to output an SOC adjustment signal for adjusting the SOC of the battery according to the target SOC; and
an SOC adjustment unit configured to adjust the SOC of the battery according to the SOC adjustment signal.

2. The battery pack of claim 1, wherein the battery pack is introduced into a specific place according to a specific situation and is configured to wake up according to a wake-up signal from the external device.

3. The battery pack of claim 2, wherein the wake-up signal is input at a predetermined cycle.

4. The battery pack of claim 3, wherein the target SOC is input differently based on a battery pack operation status, such as a long-term storage, transportation, or disposal of the battery pack.

5. The battery pack of claim 4, wherein the control unit compares the SOC estimated by the SOC estimation unit and the target SOC of the battery, to output the SOC adjustment signal.

6. The battery pack of claim 5, wherein the SOC adjustment unit comprises a switch connected to the battery and a discharge resistor connected to the switch, and
wherein the switch is driven according to the SOC adjustment signal to allow the battery to be discharged through the discharge resistor so that the SOC of the battery is lower than the target SOC.

7. The battery pack of claim 6, wherein the discharge resistor comprises a variable resistance, and the control unit adjust the variable resistance of the discharge resistor to control a temperature of the battery pack.

8. A battery pack management apparatus comprising:
at least one battery pack configured to communicate with an outside of the at least one battery pack; and
a remote managing device spaced apart from the at least one battery pack and configured to communicate with the at least one battery pack,
wherein the remote managing device sets a first target state of charge (SOC) and transmits the first target SOC to the at least one battery pack, and
wherein the at least one battery pack adjusts a pack SOC according to the first target SOC.

9. The battery pack management apparatus of claim 8, wherein the at least one battery pack is introduced into a specific place according to a specific situation and is configured to wake up according to a first wake-up signal from the remote managing device.

10. The battery pack management apparatus of claim 9, wherein the first target SOC is different depending on a battery pack operation status, such as a long-term storage, transportation or disposal of the at least one battery pack.

11. The battery pack management apparatus of claim 10, wherein the at least one battery pack comprises:
a battery including a plurality of chargeable and dischargeable battery cells;
a first communication unit configured to transmit an initial SOC of the battery to the remote managing device and receive the first target SOC from the remote managing device;
an SOC estimation unit configured to estimate the SOC of the at least one battery pack;
a control unit configured to adjust a SOC of the battery according to a comparison result of the first target SOC and the pack SOC; and
an SOC adjustment unit configured to adjust the SOC of the battery according to a control of the control unit.

12. The battery pack management apparatus of claim 11, wherein the control unit outputs a control signal for adjusting the pack SOC when the pack SOC is larger than the first target SOC.

13. The battery pack management apparatus of claim 12, wherein the SOC adjustment unit comprises a switch connected to the battery and a discharge resistor connected to the switch, and
wherein the switch is driven based on a control signal of the control unit to allow the battery to be discharged through the discharge resistor.

14. The battery pack management apparatus of claim 13, wherein the discharge resistor comprises a variable resistance, and the battery is discharged by adjusting the variable resistance of the discharge resistor so that a discharge current flowing through the discharge resistor is lower than a predetermined reference current.

15. The battery pack management apparatus of claim 14, wherein the remote managing device comprises:
a second communication unit configured to transmit a second wake-up signal and a second target SOC to the at least battery pack and receive the initial SOC from the at least one battery pack; and
a management unit configured to generate the second wake-up signal and the second target SOC and manage the at least one battery pack through the second communication unit.

16. The battery pack management apparatus of claim 15, further comprising a battery rack configured to accommodate the at least one battery pack and communicate with the at least one battery pack through wireless communication or wired communication.

17. The battery pack management apparatus of claim 16, wherein the remote managing device manages the at least one battery pack accommodated in the battery rack through the battery rack.

18. A battery pack management method comprising:
introducing at least one battery pack to a specific place depending on a specific situation;
waking up the at least one battery pack by wake-up signal;
estimating a pack state of charge (SOC) of the at least one battery pack;
receiving a target SOC from a remote managing device;
comparing the pack SOC and the target SOC;
transmitting to the remote managing device that the at least one battery pack is configured for the specific situation if the pack SOC is lower than the target SOC based on a comparison result; and
adjusting the pack SOC if the pack SOC is higher than the target SOC based on the comparison result.

19. The battery pack management method of claim 18, further comprising:
measuring a discharge current while adjusting the pack SOC and comparing the measured discharge current with a reference current; and
adjusting an SOC by increasing a resistance value of a discharge resistor if the discharge current is higher than the reference current
